(19) United States
(12) Patent Application Publication
(10) Pub. No.: US 2005/0265208 A1
(43) Pub. Date: Dec. 1, 2005

(54) Optical disk, optical disk apparatus, and method of optimizing focus

(75) Inventors: Hiroshi Nakane, Fukaya-shi (JP); Hideki Ootsuka, Mishima -shi (JP)

Correspondence Address: PILLSBURY WINTHROP SHAW PITTMAN, LLP, P.O. BOX 10500, MCLEAN, VA, 22102, US

(73) Assignee: KABUSHIKI KAISHA TOSHIBA, Tokyo (JP)

(21) Appl. No.: 10/945,260

(22) Filed: Sep. 21, 2004

(30) Foreign Application Priority Data
May 26, 2004 (JP) 2004-156233

(51) Int. Cl. G11B 7/00; G11B 7/24

(52) U.S. Cl. 369/272.1; 369/275.1; 369/283; 369/44.25

(57) ABSTRACT

An information recording type optical disk capable of recording a visible image by use of laser beam, including a disk substrate including an information recording layer in which marks indicating information are recorded by the laser beam, a label recording layer which is formed on the disk substrate and which is capable of recording the visible image, and a reflective band disposed on one of an inner peripheral side and an outer peripheral side of the label recording layer and formed into a circle concentric with the disk.

### CROSS-REFERENCE TO RELATED APPLICATIONS

This application is based upon and claims the benefit of priority from prior Japanese Patent Application No. 2004-156233, filed May 26, 2004, the entire contents of which are incorporated herein by reference.

### BACKGROUND OF THE INVENTION

1. Field of the Invention

The present invention relates to an optical disk including a label recording layer capable of recording a visible image on one surface of the disk, and an optical disk apparatus which records information in the optical disk.

2. Description of the Related Art

In recent years, as well known, optical disks such as CDs and DVDs have spread as information recording media. Examples of CDs include a read-only CD-ROM, a write-once (write-once at the same region in a disk) CD-R, a rewritable CD-RW, and examples of DVDs include a read-only DVD-ROM, a write-once DVD-R, a rewritable DVD-RAM, DVD-RW. A recording type optical disk, that is, a write-once or rewritable optical disk has an information recording layer. The recording capacity of the information recording layer is, for example, about 700 MB in the CD-R, or about 4.7 GB in DVD-R.

Characters or logos indicating the type or the like of a recording type optical disk are, for example, silk-screen printed on a label surface on a side opposite to that of an information recording layer of the disk. An optical disk including a label surface on which the characters or pictures can be recorded by an ink jet printer or handwriting has also become popular.

In recent years, documents on an optical disk and an optical disk apparatus capable of recording pictures or characters on a label surface using laser beam have been published, for example, in Jpn. Pat. Appln. KOKAI Publication No. 2002-203321.

A problem in a case where characters or pictures are printed on the label surface, as described above, printable by laser beam provided in an optical disk apparatus capable of recording information to the information recording layer will be described hereinafter.

The optical disk apparatus is optically designed in such a manner as to cancel aberration at a point at which the laser beam passed through a medium having a certain thickness reaches the surface of the recording layer. Therefore, when the laser beam is directly applied to the label surface of the disk, a lens position where a focus error signal turns to 0 differs from a lens position (this is a desired just focus position) where a sum signal of photo detection signals is maximized. This is because of spherical aberration. As a result, a servo control cannot be performed in such a manner as to maximize the sum signal using the focus error signal. That is, clear images of characters or pictures cannot be printed on the label surface. A feedforward control may be adopted using the sum signal, but there have been problems that much time is required for taking in data and that a position precision is low.

### BRIEF SUMMARY OF THE INVENTION

An optical disk according to one embodiment of the present invention is an information recording type optical disk capable of recording a visible image by use of laser beam, comprising: a disk substrate including an information recording layer in which marks indicating information are recorded by the laser beam; a label recording layer which is formed on the disk substrate and which is capable of recording the visible image; and a reflective band disposed on one of an inner peripheral side and an outer peripheral side from the label recording layer and formed into a circle concentric with the disk.

### BRIEF DESCRIPTION OF THE SEVERAL VIEWS OF THE DRAWING

The accompanying drawings, which are incorporated in and constitute a part of the specification, illustrate embodiments of the invention, and together with the general description given above and the detailed description of the embodiments given below, serve to explain the principles of the invention.

FIG. 1 is a diagram showing a structure of an optical disk according to one embodiment of the present invention;

FIG. 2 is a diagram showing a detected focus error signal and reflected light signal using a CD laser and its optical system with respect to an information recording surface of a CD disk;

FIG. 3 is a diagram showing the detected focus error signal and reflected light signal using the CD laser and its optical system with respect to a label recording surface using silk printing;

FIG. 4 is a diagram showing the detected focus error signal and reflected light signal using the CD laser and its optical system with respect to a reflective band formed by vapor-depositing aluminum;

FIG. 5 is a block diagram showing a constitution of an optical disk recording/reproducing device to which the present invention is applied;

FIG. 6 is a diagram showing characteristics of the focus error signal and a sum signal based on reflected light reflected by the surface of the disk;

FIG. 7 is a flowchart showing an operation according to a first embodiment in which laser beam is focused with respect to the surface of the disk having a bad surface roughness; and

FIG. 8 is a flowchart showing an operation according to a second embodiment in which the laser beam is focused with respect to the surface of the disk having the bad surface roughness.

### DETAILED DESCRIPTION OF THE INVENTION

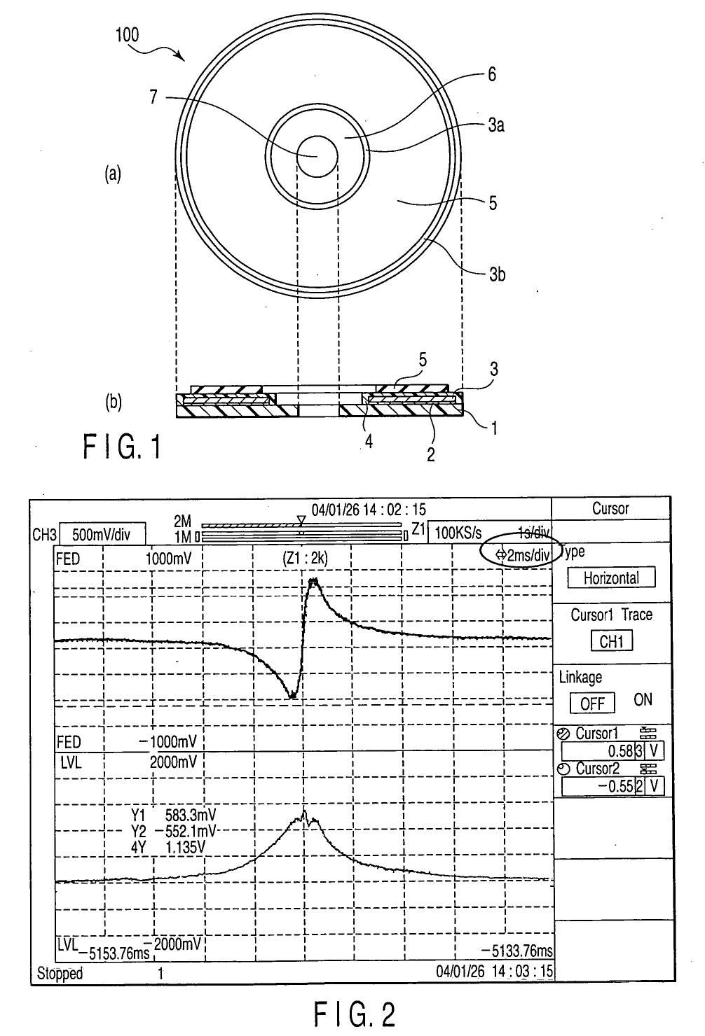

FIG. 1 is a diagram showing a structure of an information recording type optical disk 100 according to one embodiment of the present invention, (a) of FIG. 1 is a plan view, and (b) of FIG. 1 is a sectional view.

As shown in (a) of FIG. 1, on the side of the label surface of the disk 100, a donut-shaped label recording layer 5 is formed into a circle concentric with the disk 100, a reflective band 3a is disposed on an inner peripheral side of the label recording layer 5, and a reflective band 3b is disposed on an outer peripheral side. The label recording layer 5 is a layer capable of recording a visible image by laser beam. A width of each of the reflective bands 3a, 3b is larger than eccentricity of the rotating disk 100. That is, the width of each of the reflective bands 3a, 3b is larger than a positional fluctuation distance on the disk of a laser spot, owing to the eccentricity of the rotating disk 100 when the laser beam is not subjected to the tracking servo.

As shown in (b) of FIG. 1, an information recording layer 2 is formed on a disk substrate 1, and a reflective layer 3 is formed on the information recording layer. The information recording layer 2 is a layer capable of recording marks indicating information by laser beam from below in the figure. A protective film 4 is formed in such a manner as to coat the reflective layer 3, and the label recording layer 5 is formed on the film.

An additionally recordable optical disk such as a DVD-R includes the information recording layer 2 containing such a dyestuff that a reflectance of a laser applied portion permanently changes, and the recording marks indicating the information are formed using the laser beam to record the information. A rewritable optical disk such as a DVD-RAM or DVD-RW includes the information recording layer 2 whose phase changes upon irradiation of laser beam having power for writing, and the recording marks indicating the information are formed using the laser beam to record the information. The marks recorded on the rewritable optical disk can be deleted by irradiation of laser beam having power for deletion. Therefore, information can be rewritten to a region on the information recording layer 2 of the rewritable optical disk where the marks have been deleted. This also applies to a CD-R and CD-RW.

As shown in FIG. 1, the reflective layer 3 is disposed on the side of the disk substrate from the label recording layer 5, and irregular reflection on the surface of the reflective bands 3a, 3b is less than that of the label recording layer. The reflective bands 3a, 3b have a reflectance higher than that of the label recording layer. A visible image is recorded in the label recording layer 5 using the same laser as that of the information recording layer 2.

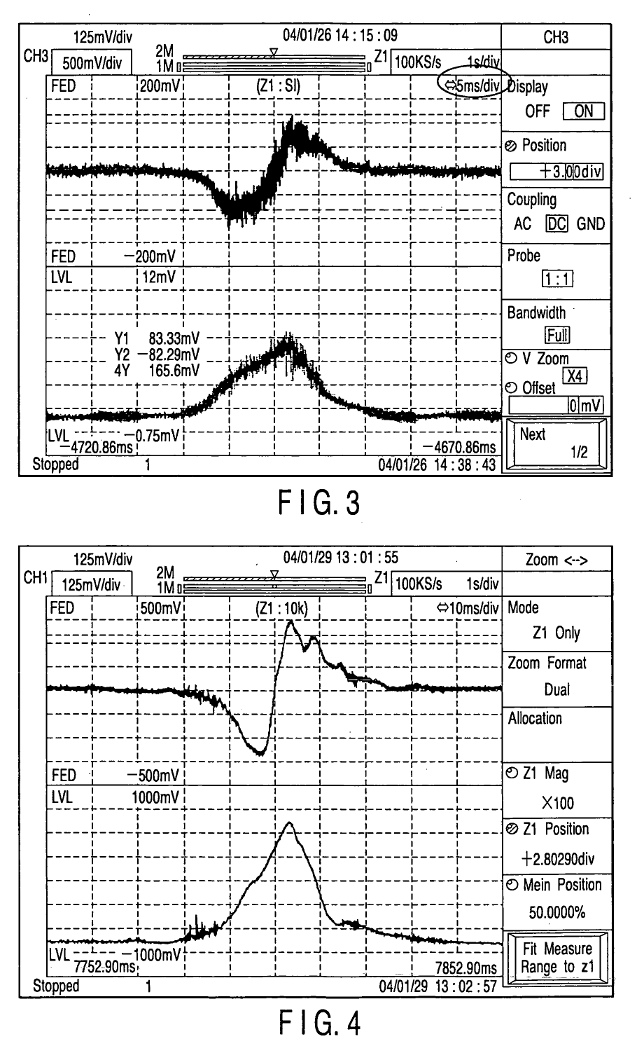

FIG. 2 shows a detected general focus error signal (upper figure) and reflected light signal (lower figure) from the information recording surface of a CD disk, using a CD laser and its optical system. FIG. 3 shows a detected focus error signal (upper figure) and reflected light signal (lower figure) from a label recording surface of silk screen printing, using the CD laser and its optical system.

FIG. 4 shows a detected focus error signal (upper figure) and reflected light signal (lower figure) from the reflective band formed by vapor-depositing aluminum, using the CD laser and its optical system.

In the label recording, since the reflectance of the label recording surface excessively low, the reflected light signal has a small signal amplitude as shown in FIG. 3, and an S/N ratio is bad. Therefore, the reflected light signal as good quality as the signal shown in FIG. 2 is not obtained. Therefore, a feedforward method which does not depend on the disk reflected light is used during the focusing.

In the feedforward method, driving force values (driving voltage values) of a focus actuator, at which a reflected light level is maximized in FIG. 3, is learned and stored with respect to a non-recorded label recording surface, then the focus actuator is driven with an open loop control on the based of the stored driving force values.

A disk surface warp in one rotation of the disk, that is, a change of height of the disk surface is learned based on the signal obtained from the reflected light in synchronization with the pulses generated from a rotation detector (described later) disposed in the disk motor. In this case, a surface warp component is divided into DC and AC components and stored. When learned data is used, a stored values (surface warp components) are supplied to the focus actuator in synchronization with the FG pulses.

However, since the label recording surface coated with a paint for silk screen printing is coarse, a quality of the signal obtained from the reflected light is low as shown in FIG. 3. Therefore, stability of focus servo is low, and a time required for the learning lengthens. This is because an averaging method has heretofore been used in order to alleviate the low signal quality of the reflected light from the label recording surface.

In the present embodiment, as shown in FIG. 1, the quality of the signal obtained from the reflected light is raised by the reflective bands 3a, 3b, the number of averaging operations can be reduced, and the learning in a short time is possible.

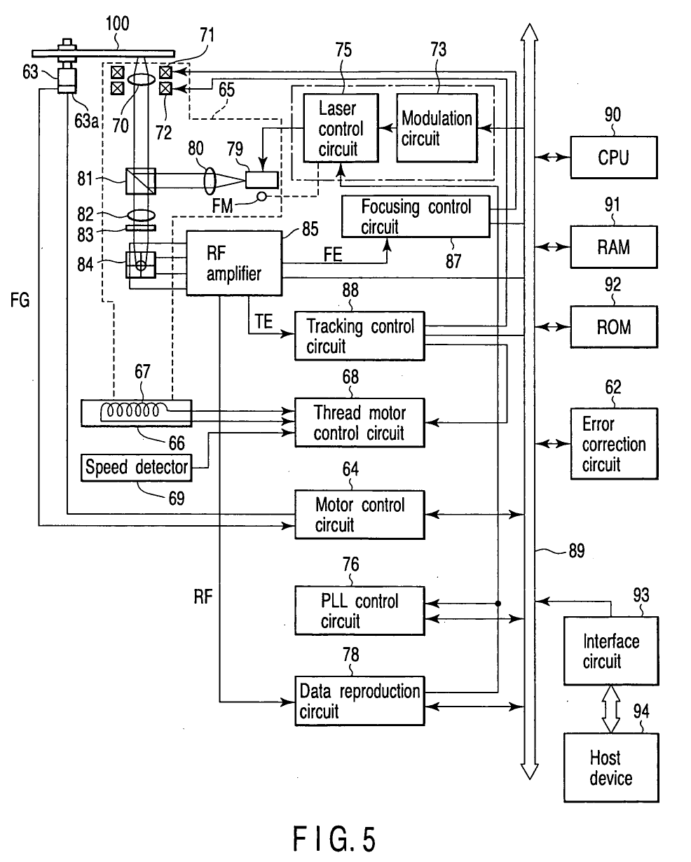

FIG. 5 is a block diagram showing a constitution of an optical disk recording/reproducing device to which one embodiment of the present invention is applied.

Land tracks and groove tracks are formed into a spiral form on the surface of the optical disk 100. The disk 100 is rotated/driven by a spindle motor 63. FG pulses are supplied from a rotation detector 63a disposed in the spindle motor 63. For example, five FG pulses are produced for every rotation of the spindle motor 63 (disk 100). A rotation angle and a rotation speed of the disk 100 can be calculated by the FG pulses.

The information is recorded/reproduced with respect to the optical disk 100 by an optical pickup head (PUH) 65. The optical pickup head 65 is connected to a thread motor 66 via a gear, and the thread motor 66 is controlled by a thread motor control circuit 68.

A speed detection circuit 69 is connected to the thread motor control circuit 68, and a speed signal of the optical pickup head 65 detected by the speed detection circuit 69 is sent to the thread motor control circuit 68. A permanent magnet (not shown) is fixed in the thread motor 66, a driving coil 67 is energized by the thread motor control circuit 68, and accordingly the optical pickup head 65 moves in a radial direction of the optical disk 100.

An objective lens 70 supported by a wire or a leaf spring (not shown) is disposed in the optical pickup head 65. The objective lens 70 is movable in a focusing direction (optical axial direction of the lens) by the driving of a driving coil 72, and is movable in a tracking direction (direction crossing an optical axis of the lens at right angles) by the driving of a driving coil 71.

A modulation circuit 73 subjects user data supplied from a host device 94 via an interface circuit 93, for example, to 8-14 modulation (EFM) to provide EFM data at the time of the recording of the information. A laser control circuit 75 supplies a writing signal to a laser diode 79 based on the EFM data supplied from the modulation circuit 73 at the time of the recording of the information (forming of a marks). The laser control circuit 75 supplies a reading signal smaller than the writing signal to the laser diode 79 at the time of the reading of the information.

A front monitor FM constituted of a photo diode detects a quantity, that is, a light emitting power of laser beam produced by the laser diode 79, and supplies a detected current to the laser control circuit 75. The laser control circuit 75 controls the laser diode 79 in such a manner as to emit the light with the laser power set by a CPU 90 for the time of the reproducing/recording, based on the detected current from the front monitor FM.

The laser diode 79 produces the laser beam in response to a signal supplied from the laser control circuit 75. The laser beam emitted from the laser diode 79 is applied onto the optical disk 100 via a collimator lens 80, a half prism 81, and the objective lens 70. Reflected light from the optical disk 100 is guided to a photo detector 84 via the objective lens 70, the half prism 81, a condenser lens 82, and a cylindrical lens 83.

The photo detector 84 is constituted of, for example, four divided photo detecting cells, and detection signals of these photo detection cells are output to an RF amplifier 85. The RF amplifier 85 processes signals from the photo detection cells to produce a focus error signal FE indicating an error from an in-focus position, a tracking error signal TE indicating an error between a center of a beam spot of laser beam and a center of the track, and an RF signal which is a total added signal of photo detection cell signals.

The focus error signal FE is supplied to a focusing control circuit 87. The focusing control circuit 87 produces a focus driving signal in response to the focus error signal FE. The focus driving signal is supplied to the driving coil 71 in the focusing direction. Accordingly, focus servo is performed in such a manner that the laser beam is constantly exactly focused on the recording film of the optical disk 100.

The tracking error signal TE is supplied to a tracking control circuit 88. The tracking control circuit 88 produces a track driving signal in response to the tracking error signal TE. The track driving signal output from the tracking control circuit 88 is supplied to the driving coil 72 in the tracking direction. Accordingly, tracking servo is performed to constantly trace the laser beam on the track formed in the optical disk 100.

When the focus servo and the tracking servo are performed, changes of the reflected light from pits or marks formed on the track of the optical disk 100 in accordance with recorded information are reflected in the total added signal RF of the output signals of the respective photo detection cells of the photo detector 84. The signal is supplied to a data reproduction circuit 78. The data reproduction circuit 78 reproduces recorded data based on a reproducing clock signal from a PLL control circuit 76.

While the objective lens 70 is controlled by the tracking control circuit 88, the thread motor 66 that is the PUH 65 is controlled by the thread motor control circuit 68 in such a manner as to position the objective lens 70 in the vicinity of a predetermined position in the PUH 65.

A motor control circuit 64, the thread motor control circuit 68, the laser control circuit 75, the PLL control circuit 76, the data reproduction circuit 78, the focusing control circuit 87, the tracking control circuit 88, an error correction circuit 62 and the like are controlled by the CPU 90 via a bus 89. The CPU 90 generally controls the recording/reproducing device in accordance with an operation command provided from the host device 94 via the interface circuit 93. The CPU 90 uses a RAM 91 as a working area, and performs a predetermined operation in accordance with control programs including a program recorded in a ROM 92 according to the present invention.

A control of focus of the laser beam with respect to the surface of the disk (label surface) having a high surface roughness according to the present invention will be described hereinafter.

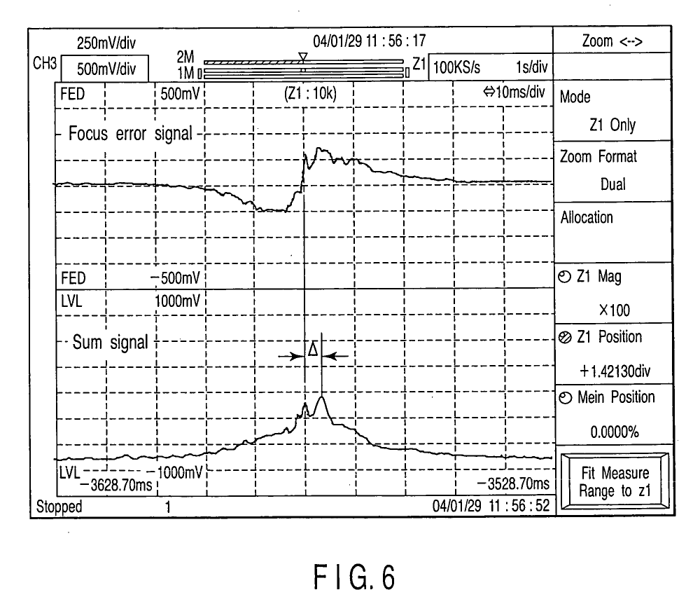

FIG. 6 is a diagram showing characteristics of the focus error signal and a sum signal based on the reflected light reflected by the surface of the disk. The total added signal RF is used as the sum signal.

The optical disk apparatus is optically designed in such a manner that aberration is canceled at a point at which the laser beam passed through a medium having a certain thickness reaches the surface of the recording layer. Therefore, when the laser beam is directly applied to the surface of the label surface of the disk, a 0 point of the focus error signal differs from a maximum point of the sum signal (this is a desired exact focus point) by the spherical aberration as shown by difference [symbol] in FIG. 6. Since the maximum point of the sum signal is in the vicinity of a vertex of an S-shape of focus error signal characteristics, a servo control cannot be performed using the focus error signal in such a manner as to maximize the sum signal. As a result, a clear character or picture image cannot be printed on the label surface.

In the present invention, in order that the laser beam is focused with respect to the surface of the disk having a high surface roughness, firstly, the optical pickup head 65 (laser beam) is moved to the reflective band 3a or 3b, which is a portion disposed on the disk and having a satisfactory surface smoothness and a high reflectance. Then, a feedback control is performed in such a manner that the focus error signal turns to 0. A servo gain adjustment, an offset adjustment of various signals and the like are performed in this state. A focus driving indication values (output signal values of the focusing control circuit 87) are stored into a memory in a state in which the feedback control (focus servo) is performed. Thereafter, the feedback control is turned off, and a feedforward control is performed using values stored in the memory. An offset is added to a focus driving indicator voltage in such a manner as to maximize the sum signal in a state in which the feedforward control is performed, and accordingly a difference between the 0 point on the S shape of the focus error signal and the maximum point of the sum signal is canceled.

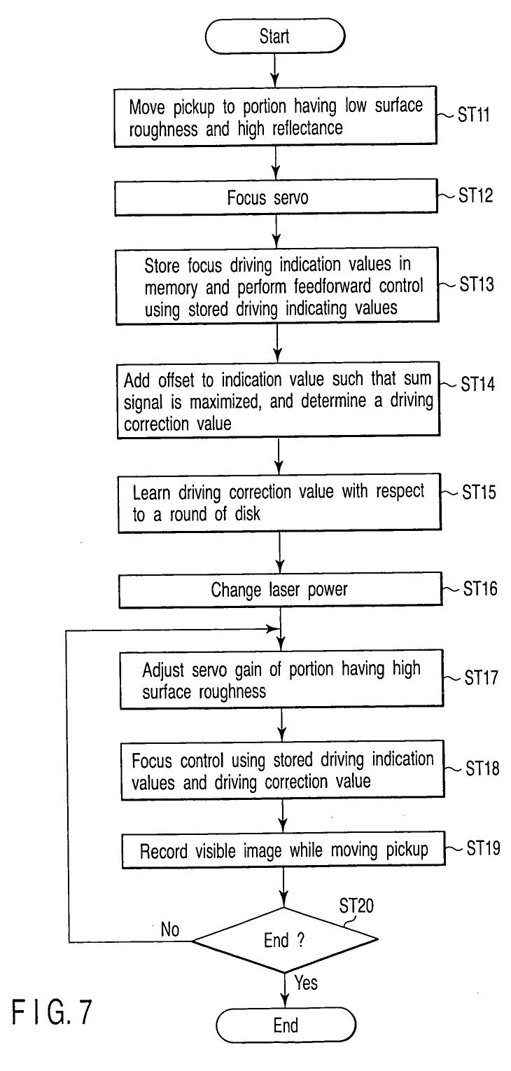

One embodiment of an operation according to the present invention will be described hereinafter in detail. FIG. 7 is a flowchart showing an operation in a case where the laser beam is focused with respect to the surface of the disk having a high surface roughness. Each step of the flowchart is executed by the CPU 90 which controls the corresponding block in the optical disk apparatus shown in FIG. 5.

Step ST11: First, the pickup head (laser beam) is moved to the reflective band 3a or 3b disposed on the disk and having a low surface roughness and a high reflectance.

Step ST12: A feedback control (focus servo) is performed using the focus error signal as described above. At this time, the focus error signal is passed through an LPF having a cutoff frequency of 5 kHz or less and used in the focus servo. A servo gain adjustment, an offset adjustment of various signals and the like are performed in this step.

Step ST13: The focus driving indication value (an output signal value of the focusing control circuit 87) with respect to each rotation angle is stored into a memory under the feedback control. The rotation angle is judged from the FG pulses. A surface warp of the disk is stored in this manner. When the focus driving indication value is stored in the memory, in order to remove signal components following the surface roughness of the disk surface, the focus driving indication value is filtered through the LPF having a cutoff frequency of 1 kHz or less and stored. Thereafter, the feedback control of the focus is turned off, and a feedforward control is performed using the focus driving indication value stored in the memory.

Step ST14: The focus driving indication value is offset in such a manner that the sum signal (total added signal RF) is maximized under the feedforward control. At this time, the offset is gradually increased for example, and if the sum signal is reduced, the offset is gradually decreased. In this way, an offset value at which the sum signal is maximized is learned (detected). The detected offset value is determined as a driving correction value and stored into a memory. The driving correction value corresponds to the difference [symbol] in FIG. 6. The driving correction value means difference between a focus indication value at a point at which the focus error signal turns to zero, and that at a point at which the sum signal is maximized.

Step ST15: The driving correction value is learned with respect to a round of a disk. That is, the driving correction value is determined with respect to each rotation angle, and the determined driving correction values are stored into the memory. The rotation angle is judged from the FG pulse.

Note that, a change of the driving correction value is usually small with respect to a round of the disk. thus, this step may be omitted.

Step ST16: The pickup is moved to the portion having the high surface roughness, and a laser power is changed in such a manner that a signal amplitude is substantially equal to that of a reflective band portion having a high reflectance.

Step ST17: A focus error signal amplitude or a sum signal amplitude at the reflective band region 3a or 3b subjected to the servo gain adjustment is compared with that at the region having the high surface roughness (label recording surface). A servo gain at the region having the high surface roughness is determined in accordance with the amplitude difference.

Step ST18: A focus control is performed using the focus driving indication values obtained in the step ST13 and the driving correction value(s) obtained in the step ST14 or step ST15. That is, the focus driving indication value is corrected by (or added to) the correction value and the focus control is performed using the corrected focus driving indication value.

Step ST19: The pickup head is moved while the visible image of the character or the picture is recorded by the laser beam.

When the recording of the visible image does not end (NO in step ST20), the process of the steps ST17 to ST19 is repeated. The laser beam is correctly focused with respect to the surface of the disk at a high speed in this manner, and the visible image can be recorded.

When the image is recorded in a new region, the feedback control (ST12 to ST16) using the focus error signal is executed again in the reflective band 3a, 3b in the vicinity of the region, and the focus driving indication value and driving correction value are stored. A triggering operation of the focus servo at the reflective band 3a, 3b, is performed such that the focus driving indicator voltage of the feedforward control is output to the actuator 71 to vertically move the lens 70, and the focus servo is turned on at a focal point.

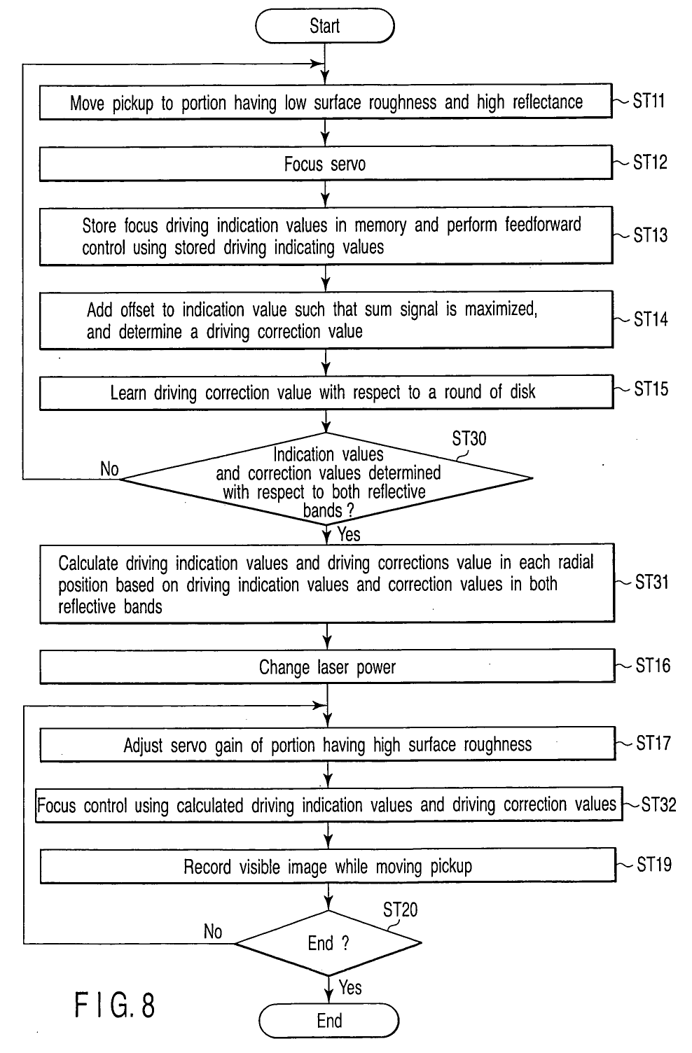

FIG. 8 is a flowchart showing a second embodiment of an operation for focusing the laser beam with respect to the label recording surface.

FIG. 8 is different from the flowchart of FIG. 7 in steps ST30, ST31, ST32, and other steps are similar. That is, in the step ST30, it is judged whether or not the focus driving indication values and the driving correction values are determined with respect to both the reflective bands 3a, 3b. If NO in step ST30, the focus driving indication values and the driving correction values of the other reflective band are also determined (ST11 to ST15). In the step ST31, the driving indication values and the driving correction values in each radial position are calculated based on the driving indication values and driving correction values in both the reflective bands. At this time, for example, assuming that the surface warp of the disk linearly changes from the reflective band 3a on an innermost periphery to the reflective band 3b on an outermost periphery, the driving indication values and driving correction values in each radial position can be calculated. In the step ST32, the focus control is performed using the driving indication value and driving correction value in each radial position calculated in the step ST31. Therefore, in the second embodiment, precision of the focus control is raised as compared with the first embodiment.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general invention concept as defined by the appended claims and their equivalents.

1. An information recording type optical disk capable of recording a visible image by use of laser beam, comprising:
a disk substrate including an information recording layer in which marks indicating information are recorded by the laser beam;
a label recording layer which is formed on the disk substrate and which is capable of recording the visible image; and
a reflective band disposed on at least one of an inner peripheral side and an outer peripheral side of the label recording layer and formed into a circle concentric with the disk.

2. The optical disk according to claim 1, wherein a reflective layer is formed between the disk substrate and the label recording layer, and the reflective band is a part of the label recording layer.

3. The optical disk according to claim 2, wherein irregular reflection on the surface of the reflective layer is less than that of the label recording layer.

4. The optical disk according to claim 1, wherein the visible image is recorded in the label recording layer by use of the same laser as that for the information recording layer.

5. The optical disk according to claim 1, wherein the reflective band has a reflectance higher than that of the label recording layer.

6. The optical disk according to claim 1, wherein a width of the reflective band is larger than an eccentricity of the disk when the disk is rotated.

7. An optical disk apparatus which records and reproduces information to and from a recording type optical disk including a label recording layer capable of recording a visible image and a reflective band formed into a circle concentric with the disk on a disk substrate, the unit comprising:
a focus servo section which moves laser beam onto the reflective band of the disk to perform focus servo;
a feedforward section which stores a focus driving indication value during the focus servo into a memory and performs a feedforward control by use of the stored focus driving indication value;
a correction section which adds offsets to the focus driving indication value in a state in which the feedforward control is performed on the reflective band and determines an offset which maximize a sum signal of reflected light as a correction value; and
an addition section which moves the laser beam onto the label recording layer to perform a feedforward control by use of the feedforward section, based on a value obtained by adding the correction value to the focus driving indication value.

8. The optical disk apparatus according to claim 7, wherein the feedforward section stores a focus driving indication value at each rotation angle of the optical disk into the memory, and
the addition section performs the feedforward control on the label recording layer, based on a value obtained by adding the correction value to the focus driving indication value at each rotation angle.

9. A method of optimizing a focus to adjust a focal point of laser beam with respect to the surface of a label recording layer of a recording type optical disk including the label recording layer capable of recording a visible image and a reflective band formed into a circle concentric with the disk on a disk substrate, the method comprising:
moving the laser beam onto the reflective band of the disk to perform focus servo;
storing a focus driving indication value during the focus servo into a memory to perform a feedforward control by use of the stored focus driving indication value;
adding an offset to the focus driving indication value in such a manner as to maximize a sum signal of reflected light in a state in which the feedforward control is performed on the reflective band;
learning a difference of the focus driving indication value between a time when a focus error signal turns to 0 and a time when the sum signal is maximized; and
moving the laser beam onto the surface of the label recording layer of the disk, and correcting the focus driving indication value by use of a value obtained by the learning to perform the feedforward control by use of the corrected focus driving indication value.
